(19) United States
(12) Patent Application Publication
(10) Pub. No.: US 2024/0357380 A1
(43) Pub. Date: Oct. 24, 2024

(54) MANAGING DECENTRALIZED AUTOENCODER FOR DETECTION OR PREDICTION OF A MINORITY CLASS FROM AN IMBALANCED DATASET

(71) Applicant: Telefonaktiebolaget LM Ericsson (publ), Stockholm (SE)

(72) Inventors: Konstantinos VANDIKAS, Solna (SE); Selim ICKIN, Danderyd (SE); Wenfeng HU, Täby (SE); Erik SANDERS, Vallentuna (SE); Paluk GOYAL, New Dehli (IN)

(21) Appl. No.: 18/687,990

(22) PCT Filed: Aug. 31, 2021
(86) PCT No.: PCT/SE2021/050844

§ 371 Date: Feb. 29, 2024

(51) Int. Cl. H04W 24/02; H04L 1/00; H04L 41/16

(52) U.S. Cl. CPC H04W 24/02; H04L 1/0033; H04L 41/16

(57) ABSTRACT

A method performed by a first communication device for managing a decentralized autoencoder for detection or prediction of a minority class from an imbalanced dataset is provided. The method includes signalling a message to communication devices including a set of parameters for the decentralized autoencoder; and receiving a message from a communication device providing information including an amount of local samples and a distribution of labels in the local samples of instances of local majority class samples and/or the local minority class samples. The method further includes computing a computed number of samples and a computed distribution of labels for aggregated local majority class samples and aggregated local minority class samples; and selecting a set of communication devices to include in the decentralized autoencoder based on the communication devices that can satisfy the computed number of samples and the computed distribution of labels.

### TECHNICAL FIELD

The present disclosure relates generally to methods for managing a decentralized autoencoder for detection or prediction of a minority class from an imbalanced dataset, and related methods and apparatuses.

### BACKGROUND

Binary classification of classes of data (e.g., prediction of key performance indicator (KPI) degradation using discretized output that is quantized as two possible outputs) in a communication network is a problem that may affect utilization and performance of the communication network. For example, cell accessibility degradation (also referred to herein as a “sleeping cell” or an “idle cell”) is an important problem in the telecommunications domain since it can decrease the utilization of networks and degrade their performance. Sleeping cells usually can be attributed to software related issues (e.g., buffer overflows/underflows) that are tolerated (e.g., by defensive software implementation treating such issues and, thus, allowing such issues to occur without disrupting other functions). However, such sleeping cells can still manifest themselves externally. While software testing can help prevent sleeping cells, sleeping cells can still be present (e.g., in low numbers). A sleeping cell is a cell in that has ongoing connections (active radio access channels) but when a new communication device (also referred to herein as a “user equipment” or “UE”) attaches, the new UE fails to utilize services such as establishing calls or relaying packets to a packet data network (PDN). In other words, a sleeping cell is available for existing UEs but not accessible for new UEs' requests.

### SUMMARY

Certain aspects of the disclosure and their embodiments may provide solutions to these or other challenges.

Various embodiments of the present disclosure, provide a method that manages a decentralized autoencoder (described further herein) to select and balance imbalanced datasets from different communication devices for the decentralized autoencoder to learn from. As used herein an “imbalanced dataset” refers to a dataset that includes more than one class of data, e.g. two classes, and distribution of samples of data across the classes, or within a class, is not uniform. The classes include a “majority class” having a greater number of samples and a “minority class” having a fewer number of samples than the majority class. The distribution of samples can range from a slight imbalance to a more severe imbalance (e.g., where there is one sample in the minority class and hundreds, thousands, millions, etc. of samples in the majority class. The term “majority class” herein may be interchangeable and replaced with the term “positive class”; the term “minority class” herein may be interchangeable and replaced with the term “negative class”; or vice versa depending on the class of prediction of interest (e.g., if the class of prediction of interest is to detect sleeping cells, then the positive class is the minority class (i.e., isSleeping=True). Additionally, when an imbalance occurs between heterogenous communication devices where a communication device has a high majority class, and another communication device has a high minority class, the communication devices can report those statistics to a communication device acting as master (referred to herein as “a first communication device” or a “master”) managing the decentralized autoencoder. Based on the statistics, the master can filter (also referred to herein as “select”) in the appropriate communications devices (i.e., the communication nodes participating in the decentralized autoencoder); or command which class the appropriate communication nodes should train on. Alternatively, the master can orchestrate two separate decoupled distributions (e.g., one distribution of the communication devices with a high majority class, and another distribution of the communication devices with a high minority class).

In some embodiments, the imbalanced dataset comprises samples of data for non-sleeping cells and samples of data for sleeping cells of a radio access network (RAN). For example, sleeping cells typically are scarce in comparison to non-sleeping cells in a RAN. Additionally, in some embodiments, the method determines a class from the imbalanced dataset (e.g., determining a class comprising data samples corresponding to sleeping cells versus a class comprising a data samples corresponding to non-sleeping cells) to use as a basis for training the decentralized autoencoder. In some embodiments, the determined class relies on RAN data and does not make use of UE information. In some embodiments, UE information is optionally added.

Certain embodiments may provide one or more of the following technical advantages. By managing a decentralized autoencoder for detection or prediction of a minority class from an imbalanced dataset, a smaller training dataset may be used in contrast to training datasets of some decentralized or distributed learning approaches. The smaller training dataset results from the decentralized autoencoder of various embodiments of the present disclosure learning from the distribution of one class from the imbalanced dataset. An additional potential advantage of the smaller dataset may be less training time and a smaller network footprint. Yet another potential advantage of various embodiments of the present disclosure is utilization of distributed datasets of a plurality of communication devices, as opposed to collecting data in a single repository, which may reduce the amount of information transferred over the communication network.

In various embodiments, a method performed by a first communication device in a communication network for managing a decentralized autoencoder for detection or prediction of a minority class from an imbalanced dataset is provided. The imbalanced dataset including a plurality of local majority class samples and a plurality of local minority class samples. The method comprises signalling a message to a plurality of other communication devices in the communication network. The message includes a set of parameters for the decentralized autoencoder. The method further includes receiving a message from at least some of the plurality of other communication devices providing information on a composition of data of the communication device that signaled the message. The composition includes an amount of local samples and a distribution of labels in the local samples of instances of the local majority class samples and/or the local minority class samples of the communication device. The method further includes computing, from the information, a computed information comprising a computed number of samples and a computed distribution of labels for aggregated local majority class samples and aggregated local minority class samples for the at least some of the plurality of other communication devices. The method further includes selecting a set of communication devices from the at least some of the plurality of other communication devices to include in the decentralized autoencoder based on the communication devices that can satisfy the computed number of samples and the computed distribution of labels.

In some embodiments, the computed number of samples include a set of balanced datasets comprising a training dataset, a test dataset, a validation dataset, and an imbalanced dataset; and the method further includes signalling a request message to the set of communication devices requesting that each communication device in the set of communication devices iteratively train and validate a local version of the autoencoder on the training dataset and the validation dataset and the set of parameters for the decentralized autoencoder. The iterative training is performed by including a dataset from either the local majority class samples or the local minority class samples that has a greatest number of samples in the training dataset and the validation dataset, respectively, as input to the local version of the autoencoder.

In some embodiments, the method further includes, subsequent to the iterative training, signalling a request to the set of communication devices requesting that each communication device in the set of communication devices evaluate the local version of the autoencoder using their local imbalanced dataset. The method further includes receiving a response to the request for evaluation from at least some of the set of communication devices. The response includes a local set of parameters for the local version of the autoencoder and at least one score for the evaluation. The at least one score is based on a reconstruction loss of the local version of the autoencoder using the imbalanced dataset as input to the local version of the autoencoder. The imbalanced dataset contains either the local majority class dataset or the local minority class dataset that was not used in the iterative training. The method further includes averaging the local set of parameters received from the at least some of the set of communication devices into an averaged set of parameters. The method further includes averaging the at least one score received from the at least some of the set of communication devices into an averaged score. The method further includes accepting (1611) the decentralized autoencoder when the averaged model performance exceeds a defined threshold.

In some embodiments, the method further includes signalling a message to the at least some of the set of communication devices including the averaged set of parameters for the accepted decentralized autoencoder.

In other embodiments, a first communication device for managing a decentralized autoencoder for detection or prediction of a minority class from an imbalanced dataset is provided. The imbalanced dataset including a plurality of local majority class samples and a plurality of local minority class samples. The first communication device includes at least one processor configured to perform operations including signal a message to a plurality of other communication devices in the communication network, the message comprising a set of parameters for a decentralized autoencoder. The operations further include receive a message from at least some of the plurality of other communication devices providing information on a composition of data of the communication device that signaled the message, the composition comprising an amount of local samples and a distribution of labels in the local samples of instances of the local majority class samples and/or the local minority class samples of the communication device. The operations further include compute, from the information, a computed information comprising a computed number of samples and a computed distribution of labels for aggregated local majority class samples and aggregated local minority class samples for the at least some of the plurality of the at least some of the plurality of other communication devices. The operations further include select a set of communication devices from the at least some of the plurality of other communication devices to include in a decentralized autoencoder based on the communication devices that can satisfy the computed number of samples and the computed distribution of labels.

In other embodiments, a first communication device for managing a decentralized autoencoder for detection or prediction of a minority class from an imbalanced dataset is provided. The imbalanced dataset including a plurality of local majority class samples and a plurality of local minority class samples. The first communication device adapted to perform operations comprising signal a message to a plurality of other communication devices in the communication network, the message comprising a set of parameters for a decentralized autoencoder. The operations further include receive a message from at least some of the plurality of other communication devices providing information on a composition of data of the communication device that signaled the message, the composition comprising an amount of local samples and a distribution of labels in the local samples of instances of the local majority class samples and/or the local minority class samples of the communication device. The operations further include compute, from the information, a computed information comprising a computed number of samples and a computed distribution of labels for aggregated local majority class samples and aggregated local minority class samples for the at least some of the plurality of the at least some of the plurality of other communication devices. The operations further include select a set of communication devices from the at least some of the plurality of other communication devices to include in a decentralized autoencoder based on the communication devices that can satisfy the computed number of samples and the computed distribution of labels.

In other embodiments, a computer program comprising program code to be executed by processing circuitry of a first communication device is provided, whereby execution of the program code causes the first communication device to perform operations comprising signal a message to a plurality of other communication devices in the communication network, the message comprising a set of parameters for a decentralized autoencoder. The operations further include receive a message from at least some of the plurality of other communication devices providing information on a composition of data of the communication device that signaled the message, the composition comprising an amount of local samples and a distribution of labels in the local samples of instances of the local majority class samples and/or the local minority class samples of the communication device. The operations further include compute, from the information, a computed information comprising a computed number of samples and a computed distribution of labels for aggregated local majority class samples and aggregated local minority class samples for the at least some of the plurality of the at least some of the plurality of other communication devices. The operations further include select a set of communication devices from the at least some of the plurality of other communication devices to include in a decentralized autoencoder based on the communication devices that can satisfy the computed number of samples and the computed distribution of labels.

In other embodiments, a computer program product comprising a non-transitory storage medium including program code to be executed by processing circuitry of a first communication device is provided, whereby execution of the program code causes the first communication device to perform operations comprising signal a message to a plurality of other communication devices in the communication network, the message comprising a set of parameters for a decentralized autoencoder. The operations further include receive a message from at least some of the plurality of other communication devices providing information on a composition of data of the communication device that signaled the message, the composition comprising an amount of local samples and a distribution of labels in the local samples of instances of the local majority class samples and/or the local minority class samples of the communication device. The operations further include compute, from the information, a computed information comprising a computed number of samples and a computed distribution of labels for aggregated local majority class samples and aggregated local minority class samples for the at least some of the plurality of the at least some of the plurality of other communication devices. The operations further include select a set of communication devices from the at least some of the plurality of other communication devices to include in a decentralized autoencoder based on the communication devices that can satisfy the computed number of samples and the computed distribution of labels.

In other embodiments, a method performed by a second communication device in a communication network is provided. The second communication device comprising an autoencoder that is also trained across a plurality of other communication devices, thereby forming a decentralized autoencoder, for detection or prediction of a minority class from an imbalanced dataset that includes a plurality of local majority class samples and a plurality of local minority class samples to the communication devices. The method includes receiving a message from a first communication device in the communication network, the message comprising a set of parameters for the decentralized autoencoder. The method further includes establishing a local copy of the autoencoder at the second communication device using the set of parameters. The method further includes signalling a message to the first communication device providing information on a composition of data of the second communication device, the composition comprising an amount of local samples and a distribution of labels in the local samples of instances of the local majority class samples and/or the local minority class samples of the second communication device. The method further includes receiving a message from the first communication device indicating that the second communication device is included in the decentralized autoencoder based on the first communication device determining that the second communication device can satisfy a computed number of samples and a computed distribution of labels for the local majority class samples and the local minority class samples at the second communication device.

In some embodiments, the computed number of samples comprise a set of balanced datasets comprising a training dataset, a test dataset, a validation dataset, and an imbalanced dataset; and the method further includes receiving a request message from the first communication device requesting that the second communication device iteratively train and validate the local version of the autoencoder on the training dataset and the validation dataset and the set of parameters for the decentralized autoencoder, wherein the iterative training is performed by including either the local majority class samples or the local minority class samples that has a greatest number of samples in the training dataset and the validation dataset, respectively, as input to the local version of the autoencoder.

In some embodiments the method further includes, subsequent to the iterative training, receiving a request from the first communication device requesting that the second communication device evaluate the local version of the autoencoder using the imbalanced dataset. The method further includes signalling a response to the first communication device to the request for evaluation, the response including a local set of parameters for the local version of the autoencoder and at least one score for the evaluation, wherein the at least one score is based on a reconstruction loss of the local version of the autoencoder using the imbalanced dataset as input to the local version of the autoencoder, and wherein the imbalanced dataset contains either the local majority class dataset or the local minority class dataset that was not used in the iterative training.

In some embodiments, the method further includes receiving a message from the first communication device comprising an averaged set of parameters for the decentralized autoencoder accepted by the first communication device.

In other embodiments, a second communication device is provided, the second communication device comprising an autoencoder that is also trained across a plurality of other communication devices, thereby forming a decentralized autoencoder, for detection or prediction of a minority class from an imbalanced dataset that includes a plurality of local majority class samples and a plurality of local minority class samples. The second communication device includes at least one processor configured to perform operations including receive a message from a first communication device in the communication network, the message comprising a set of parameters for the decentralized autoencoder. The operations further include establish a local copy of the autoencoder at the second communication device using the set of parameters. The operations further include signal a message to the first communication device providing information on a composition of data of the second communication device, the composition comprising an amount of local samples and a distribution of labels in the local samples of instances of the local majority class samples and/or the local minority class samples of the second communication device. The operations further include receive a message from the first communication device indicating that the second communication device is included in the decentralized autoencoder based on the first communication device determining that the second communication device can satisfy a computed number of samples and a computed distribution of labels for the local majority class samples and the local minority class samples at the second communication device.

In other embodiments, a second communication device for managing a decentralized autoencoder for detection or prediction of a minority class from an imbalanced dataset is provided. The imbalanced dataset including a plurality of local majority class samples and a plurality of local minority class samples. The second communication device adapted to perform operations comprising receive a message from a first communication device in the communication network, the message comprising a set of parameters for the decentralized autoencoder. The operations further include establish a local copy of the autoencoder at the second communication device using the set of parameters. The operations further include signal a message to the first communication device providing information on a composition of data of the second communication device, the composition comprising an amount of local samples and a distribution of labels in the local samples of instances of the local majority class samples and/or the local minority class samples of the second communication device. The operations further include receive a message from the first communication device indicating that the second communication device is included in the decentralized autoencoder based on the first communication device determining that the second communication device can satisfy a computed number of samples and a computed distribution of labels for the local majority class samples and the local minority class samples at the second communication device.

In other embodiments, a computer program comprising program code to be executed by processing circuitry of a second communication device is provided, whereby execution of the program code causes the second communication device to perform operations comprising receive a message from a first communication device in the communication network, the message comprising a set of parameters for the decentralized autoencoder. The operations further include establish a local copy of the autoencoder at the second communication device using the set of parameters. The operations further include signal a message to the first communication device providing information on a composition of data of the second communication device, the composition comprising an amount of local samples and a distribution of labels in the local samples of instances of the local majority class samples and/or the local minority class samples of the second communication device. The operations further include receive a message from the first communication device indicating that the second communication device is included in the decentralized autoencoder based on the first communication device determining that the second communication device can satisfy a computed number of samples and a computed distribution of labels for the local majority class samples and the local minority class samples at the second communication device.

In other embodiments, a computer program product comprising a non-transitory storage medium including program code to be executed by processing circuitry of a second communications device is provided, whereby execution of the program code causes the second communication device to perform operations comprising receive a message from a first communication device in the communication network, the message comprising a set of parameters for the decentralized autoencoder. The operations further include establish a local copy of the autoencoder at the second communication device using the set of parameters. The operations further include signal a message to the first communication device providing information on a composition of data of the second communication device, the composition comprising an amount of local samples and a distribution of labels in the local samples of instances of the local majority class samples and/or the local minority class samples of the second communication device. The operations further include receive a message from the first communication device indicating that the second communication device is included in the decentralized autoencoder based on the first communication device determining that the second communication device can satisfy a computed number of samples and a computed distribution of labels for the local majority class samples and the local minority class samples at the second communication device.

In another embodiment, a method performed by a first network node in a communication network for using a decentralized autoencoder for detection or prediction of a minority class from an imbalanced dataset is provided. The imbalanced dataset that includes a plurality of local majority class samples and a plurality of local minority class samples. The method includes triggering the decentralized autoencoder using a measurement from the communication network to learn a class from the imbalanced dataset for a future time period. The method further includes signalling information about the class to a second network node to communicate to a communication device when the communication device tries to connect to the second network node.

In other embodiments, a first network node for using a decentralized autoencoder for detection or prediction of a minority class from an imbalanced dataset is provided. The imbalanced dataset includes a plurality of local majority class samples and a plurality of local minority class samples. The first network node includes at least one processor configured to perform operations including trigger the decentralized autoencoder using a measurement from the communication network to learn a class from the imbalanced dataset for a future time period. The operations further include signal information about the class to a second network node to communicate to a communication device when the communication device tries to connect to the second network node.

In other embodiments, a first network node for using a decentralized autoencoder for detection or prediction of a minority class from an imbalanced dataset is provided. The imbalanced dataset includes a plurality of local majority class samples and a plurality of local minority class samples. The first network node adapted to perform operations comprising trigger the decentralized autoencoder using a measurement from the communication network to learn a class from the imbalanced dataset for a future time period. The operations further include signal information about the class to a second network node to communicate to a communication device when the communication device tries to connect to the second network node.

In other embodiments, a computer program comprising program code to be executed by processing circuitry of a first network node is provided, whereby execution of the program code causes the first network node to perform operations comprising trigger the decentralized autoencoder using a measurement from the communication network to learn a class from the imbalanced dataset for a future time period. The operations further include signal information about the class to a second network node to communicate to a communication device when the communication device tries to connect to the second network node.

In other embodiments, a computer program product comprising a non-transitory storage medium including program code to be executed by processing circuitry of a first network node is provided, whereby execution of the program code causes the first network node to perform operations comprising trigger the decentralized autoencoder using a measurement from the communication network to learn a class from the imbalanced dataset for a future time period. The operations further include signal information about the class to a second network node to communicate to a communication device when the communication device tries to connect to the second network node.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a communications network illustrating devices that may perform tasks of communication devices and/or network nodes according to some embodiments of the present disclosure;

FIG. 2 is block diagram illustrating an autoencoder that may perform according to some embodiments of the present disclosure;

FIG. 3 is a sequence diagram illustrating a selection and learning process in accordance with some embodiments of the present disclosure;

FIG. 4 is a plot illustrating reconstruction loss of a decentralized autoencoder in accordance with some embodiments of the present disclosure;

FIG. 5 is a plot illustrating latent space of a decentralized autoencoder in accordance with some embodiments of the present disclosure;

FIGS. 6A and 6B are plots illustrating evaluation results of a federated learning model (FIG. 6A) and the decentralized autoencoder of some embodiments of the present disclosure (FIG. 6B);

FIG. 7 is a sequence diagram illustrating a long term evolution (LTE) radio resource control (RRC) connection with sleeping cell awareness in accordance with some embodiments of the present disclosure;

FIG. 8 is a plot illustrating sleeping cell—true positive classification in accordance with some embodiments of the present disclosure;

FIG. 9 is a plot illustrating non-sleeping cell—true negative classification in accordance with some embodiments of the present disclosure;

FIGS. 10 and 11 are plots illustrating results for non-sleeping cells in accordance with some embodiments of the present disclosure;

FIG. 12 is a block diagram illustrating a communication device (e.g., a data center, mobile device or user equipment, UE) according to some embodiments of the present disclosure;

FIG. 13 is a block diagram illustrating a network node (e.g., a radio base station, eNB/gNB) according to some embodiments of the present disclosure;

FIG. 14 is a block diagram illustrating a core network CN node (e.g., an AMF node, an SMF node, etc.) according to some embodiments of the present disclosure;

FIGS. 15 and 16 are flow charts illustrating operations of a first communication device according to some embodiments of the present disclosure;

FIGS. 17 and 18 are flow charts illustrating operations of a second communication device according to some embodiments of the present disclosure;

FIG. 19 is a flow chart illustrating operations of a first network node according to some embodiments of the present disclosure;

FIG. 20 is a block diagram of a communication system in accordance with some embodiments of the present disclosure;

FIG. 21 is a block diagram of a user equipment in accordance with some embodiments of the present disclosure;

FIG. 22 is a block diagram of a network node in accordance with some embodiments of the present disclosure;

FIG. 23 is a block diagram of a host computer communicating with a user equipment in accordance with some embodiments of the present disclosure; and

FIG. 24 is a block diagram of a virtualization environment in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Potential problems exist with machine learning-based approaches for training and aggregating a machine learning model from multiple participant devices having decentralized measurements, including an imbalance of classes, etc., for supervised binary classification of data or prediction of KPI degradation in a communication network.

In some artificial intelligence (AI) based approaches for detecting sleeping cells, autoencoders are used to train models that may be capable of distinguishing sleeping cells from non-sleeping cells based on reconstruction loss. See e.g., U. Masood, A. Asghar, A. Imran, A. Noor Mian, Deep Learning based Detection of Sleeping Cells in Next Generation Cellular Networks, 2018 IEEE Global Communications Conference (21 Feb. 2019) (“Masood”); and S. Chernov, M. Cochez, T. Ristaniemi, Anomaly Detection Algorithms for the Sleeping Cell Detection in LTE Networks, 2015 IEE 81st Vehicular Technology Conference (2 Jul. 2015) (“Chernov”). Such approaches, however, require the use of the minimization of drive tests (MDT) feature introduced by Third Generation Partnership Project (3GPP) in release 11 which makes use of real UEs to collect measurements from the network which are then used to produce a labelled dataset and train the model. Potential problems with this approach include: (1) Breach of privacy because data collected from the UE can be used to track the owner of the UE; (2) A large volume of information is collected in order to find only a few (e.g., 100-200) samples of cells that may be sleeping since typically sleeping cells constitute a minority of samples; and (3) Such approaches do not take into account the state of the Radio Access Network (RAN) but instead learns from the effect, e.g., that a UE fails to make a phone call or fails to transfer data to the PDN.

Federated learning is a technique that may be used to try to overcome the breach of privacy concern. See e.g., D. Preuveneers, V. Rimmer, et. Al, Chained Anomaly Detection Models for Federated Learning: An Intrusion Detection Case Study, App. Sci. 2018, 8(12), 2663 (18 Dec. 2018). In federated learning, a centralized node may maintain a global machine learning (ML) model which is created by aggregating the ML models/weights which are trained in an iterative process at participating nodes using local data. However, the application of federated learning alone may not be enough because different distributed datasets need to be selected and partitioned in such a way that a ML model can be trained leveraging an imbalanced dataset (e.g., a highly imbalanced dataset).

Additionally, the approaches of Masood and Chernov lack explainability (e.g., explaining and interpreting behavior of the ML model) and, thus, it can be difficult to know how each feature contributed to a target variable. This potential problem may mainly a result of, in autoencoder based anomaly detection, there is no target variable per say. Rather, there are only reconstructed samples. Various embodiments of the present disclosure may provide potential technical advantages over such approaches by including a method that can show how reconstruction loss can be used in order to determine feature importance.

In B. Ravi Kiran, D. Matthew Thomas, R. Parakkal, An Overview of Deep Learning Based Methods for Unsupervised and Semi-Supervised Anomaly Detection in Videos, J. Imaging 2018, 4(2), 36 (7 Feb. 2018) (“Kiran”), different approaches are listed of using deep neural networks to solve an anomaly detection problem, including constructive autoencoders. A constructive autoencoder may learn low-dimensional discriminative representations for both positive (+) and negative (−) classes of data by minimizing the reconstruction error for positive examples while ensuring that those of the negative class are pushed away from the manifold. However, this approach does not include a distributed learning setup encouraged by limitations such as (1) bandwidth/cost/latency limitations of the data pipe, and (2)data privacy/regulatory concerns. Various embodiments of the present disclosure may provide potential technical advantages over such approaches based on learning only one class of data. As discussed further herein, experimental results from use of the method of some embodiments show that it is sufficient to learn only a negative class of data to achieve good performance (e.g., very good performance) of the decentralized autoencoder, and the implementation of such a decentralized autoencoder may be simpler and cheaper.

In a published patent application WO2020064094, “Method and System for Predicting a State of a Cell in a Radio Access Network”, a prediction module performs a binary classification supervised learning task. However, when an imbalanced dataset is present, performance of the supervised learning model may need improvement. A comparison of the approach of the to the published patent application to the method of some embodiments of the present disclosure is illustrated in FIGS. 6A and 6B (discussed further herein).

As discussed above, existing approaches include potential problems including breach of privacy concerns, volumes and location of data collected, latency concerns, volume of a training dataset for training, training time, and network footprint.

The method of various embodiments of the present disclosure includes performing a binary classification supervised learning task when an imbalanced dataset is present. In some embodiments, reconstruction loss can be used in order to determine feature importance for reconstructed samples.

Certain embodiments may provide one or more of the following technical advantages. By managing a decentralized autoencoder for detection or prediction of a minority class from an imbalanced dataset, privacy may be preserved for the communication devices participating in the decentralized autoencoder. The method of such embodiments does not use data from the participating communication devices and, instead, uses RAN data (such as performance metric (PM) counters which are collected otherwise) to ascertain quality metrics of the RAN.

Another potential advantage of various embodiments of the present disclosure is utilization of distributed datasets of a plurality of communication devices participating in the decentralized autoencoder, as opposed to, e.g., collecting data in a single repository, which may reduce the amount of information transferred over the communication network. Moreover, the method includes operations that treat sleeping cells in production. As a consequence, a software update for treating sleeping cells may not be needed.

Another potential advantage of various embodiments of the present disclosure using a decentralized autoencoder for detection or prediction of a minority class or a majority class from an imbalanced dataset is reduced latency. For example, when the decentralized autoencoder is used for supervised learning of sleeping cells, the method need not wait until a communication device identifies a cell is unavailable. Instead, the method trains the decentralized autoencoder to learn to predict that a cell is unavailable over the RAN dataset. Additionally, various embodiments of the present disclosure can be vendor-agnostic in that the method does not access or have knowledge on how each of the cells in the RAN work or their respective inner states. Rather, various embodiments, instead observe measurements (e.g., PM counters that measure a cell's behavior cumulatively).

Yet another potential advantage of various embodiments of the present disclosure includes that a smaller training dataset may be used in contrast to, e.g., training datasets of some distributed learning approaches. The smaller training dataset results from the decentralized autoencoder of various embodiments of the present disclosure learning from the distribution of one class from the imbalanced dataset. An additional potential advantage of the smaller dataset may be less training time and a smaller network footprint.

Another potential advantage of various embodiments of the present disclosure is explainability. For example, reconstruction loss from detection or prediction of a minority class or a majority class may be used to explain whether a key performance indicator (KPI) in the communication network will improve or deteriorate performance of the communication network throughput and/or latency (e.g., predict whether a certain KPI indicates cell accessibility degradation (e.g., whether a certain KPI indicates a sleeping cell; predict whether a certain KPI indicates improves (or deteriorates) throughput and/or latency, etc.).

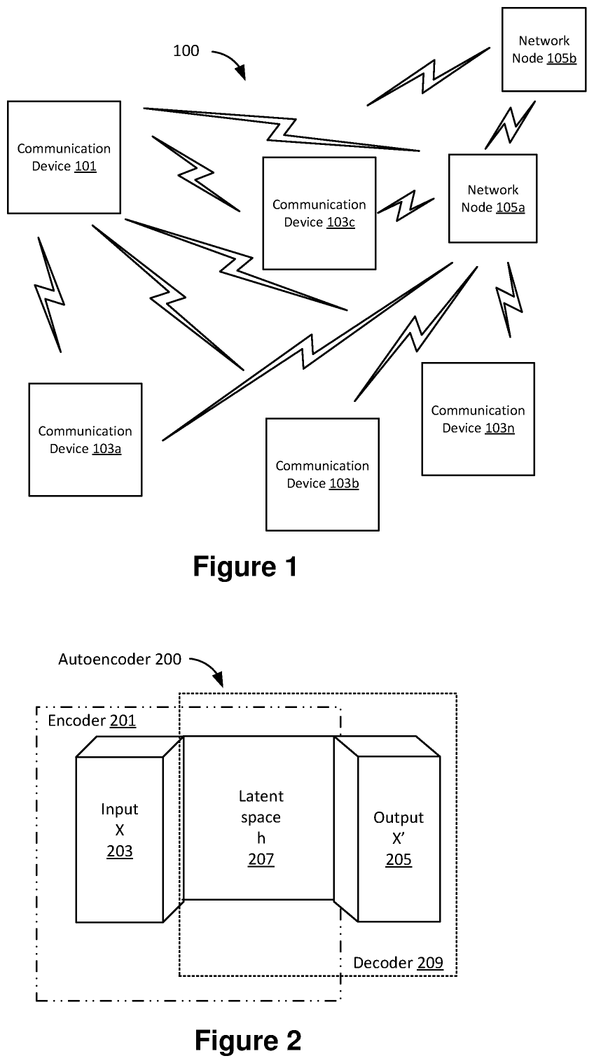

FIG. 1 is a diagram illustrating an example communication network 100 where the inventive concepts described herein may be used. In FIG. 1, communication device 101 (which may be referred to as a “parameter server” in some embodiments), communication devices 103a-103n (which each may be referred to as a “data center” in some embodiments), and network nodes 105a, 105b (which may be referred to as “base stations” or as “network operations centers” in some embodiments) are part of the communication network 100. While FIG. 1 illustrates four communication devices 103a . . . 103n, in practice, communication devices 103a . . . 103n can include any non-zero number of communication devices. Similarly, while FIG. 1 illustrates two network nodes 105a, 105b, in practice communications network 100 can include any non-zero number of network nodes.

FIG. 2 is block diagram illustrating an autoencoder 200. See e.g., https://en.wikipedia.org/wiki/Autoencoder#/media/File:Autoencoder_schema.png. An autoencoder is a machine learning model (“model”) that is a type of neural network that can perform the equivalent of an identity function. In other words, the output from the autoencoder should be the same as the input to the autoencoder. Given that the training process of a neural network is stochastic by nature, a true identity function is not likely to be achieved. Instead, an autoencoder may yield an approximation that comes as close as possible to the identity function. Autoencoder 200 includes encoder 201 and decoder 209. Input x (shown as 203) is input to encoder 201, which maps input x into latent space h (shown as 207) of autoencoder 200. Decoder 209 maps the latent space h to a reconstruction of input x. The reconstructed input is output as x′ (shown as 205) from decoder 209. As used herein, “neural parameters” refers to the entire autoencoder 200 (including encoder 201 and decoder 209). The term “parameters” herein may be interchangeable and replaced with the term “neural parameters”.

As used herein, a “decentralized autoencoder” refers to an autoencoder that is a global model shared by a plurality of communication devices (e.g., communication devices 103a . . . 103n) forming a federation. Each of the plurality of communication devices include a local copy (or version) of the autoencoder. A respective communication device participating in the decentralized autoencoder federation can improve on its respective local copy of the autoencoder with supervised learning of a representation of a distribution of samples from local data of the respective communication device. The respective communication device can summarize changes from its learning, and provide the summary to another communication device that is a master (e.g., communication device 101) that maintains the decentralized autoencoder, including averaging of the summary with summaries from other communication device participating in the decentralized autoencoder federation. The local data remains on the respective communication devices (e.g., communication devices 103a . . . 103n). With respect to various embodiments of the present disclosure, this learning process is also referred to herein as “distributed learning” or “decentralized learning”. Additionally, a request can be input to a local copy of the autoencoder to reproduce a data distribution and, based on outlier detection on a reconstruction loss of the output, one class can be determined from the other class within a margin of certainty.

For ease of discussion, four phases of operations of the method of various embodiments will be discussed. While embodiments are explained in the non-limiting context of four phases, the operations noted in the phases may occur out of the order noted in the phases. For example, two operations may be described in succession but may in fact be executed substantially concurrently or the operations may sometimes be executed in the reverse order, depending upon the operations involved. Moreover, the operations may be separated into multiple operations and/or the operations of two or more operations may be at least partially integrated. Finally, other operations may be added/inserted between the operations blocks that are described, and/or operations may be omitted without departing from the scope of inventive concepts.

In a first phase, data is collected, processed, and labelled. In a second phase, distributed learning for the autoencoder is performed. In a third phase, an inference (or in other words, a prediction) is performed (e.g., an inference of sleeping cells). In a fourth phase, notification of communication devices is performed, and in some embodiments reparation of sleeping cells.

Referring to the first phase, data is collected, preprocessed, and labelled to generate different datasets. As illustrated in in the example embodiment of FIG. 1, communication network 100 includes network nodes 105a, 105b (e.g., a network node can be a base station such as an eNodeB or a gNodeB comprised of one or more cells where a cell is a set of antennas covering a certain region). Network nodes 105a, 105b send different PM counters to regional data centers (e.g., communication devices 103a . . . 103n). Data is collected in data centers (communication devices 103a . . . 103n) as illustrated in FIG. 1. Each data center runs a process for preprocessing and labelling the data. In an example embodiments, the following non-exhaustive list includes some of the PM counters which are used as input for the method: Cell availability, data volume per cell, radio access channel establishment attempts (e.g., success/failure), throughput per cell, radio resource scheduling (success/failures), etc.

The preprocessing operation includes performance of typical data cleaning tasks such as duplicate removal, removal of samples that have missing or out of range values, and calculation of additional features such as the standard deviation of different PM counters to enrich the input dataset.

The labelling operation includes labelling each sample (e.g., as a sleeping cell or a non-sleeping cell). In some embodiments, a way of labelling each sample uses the following rule: If a cell's availability over a period of time is 100 and the average volume of data going through the cell over the same period is zero and the number of PM random access channel (RACH) Attempts contention based RACH (CBRA) is greater than 50, then this sample (for this cell) is considered to be a sleeping cell. This rule can be expressed as: Avg_cell_availability==100 AND avg_data_volume==0 AND PM_RACH_Attempts_CBRA>50.

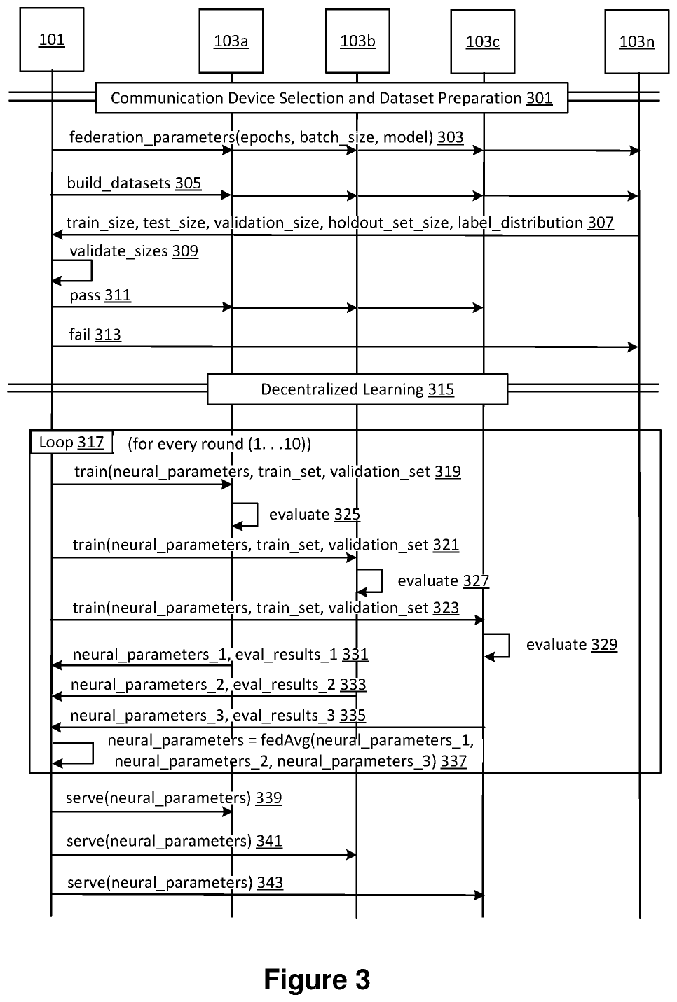

Referring to phase 2, decentralized learning is used to train the decentralized autoencoder that learns from the different datasets available from communication devices 103a . . . 103n. FIG. 3 is a sequence diagram illustrating a selection and learning process in accordance with some embodiments of the present disclosure. Referring to FIG. 3, communication device 101 communicates 301 with the corresponding communication devices 103a . . . 103n the parameters of the federation such as the type of autoencoder (e.g., the type of neural network), the number of epochs, and batch_size. Each communication device 103a . . . 103n shares information with communication device 101 about the number of samples it has and the label distribution or the number of samples that are marked as a minority dataset class (e.g., sleeping) and the number of samples that are marked as a majority dataset class (e.g., non-sleeping). Once that is received, communication device 101 (e.g., a parameter server (PS)) computes 305 the expected size and label distribution for a training dataset, test dataset, validation dataset, and hold out dataset and communicates them to the communication devices 103a . . . 103n. Communication devices 103a . . . 103n that cannot fulfill those requirements are excluded from the federation (shown as “fail” in operation 313 of FIG. 3). In the example embodiment of FIG. 3, communication device 103n is shown as a communication device that could not fulfill the requirements and is excluded from the federation. Once the decentralized autoencoder is produced, decentralized learning 315 (e.g., federated learning as it is known in the state of the art) is performed in operations 319-323. Loop 317 is performed for 10 iterations (also referred to as rounds). While this example embodiment is explained in the non-limiting context of 10 iterations, the invention is not so limited, and other numbers of iterations may be included. In each iteration, each communication device 103a-103c is requested to evaluate 329 the local autoencoder using the local hold out data set and in operations 331-335 record scores on communication device 101 such as f1 score, precision and recall. An “f1 score” refers to the harmonic mean of precision and recall. An f1 score is used to measure the accuracy of a test, which in various embodiments of the present disclosure is predictions produced by the autoencoder. If the scores are higher than a certain threshold t, the autoencoder is accepted and used 343 for inference purposes in a production autoencoder service environment.

Still referring to FIG. 3, the function build_datasets 305 requests from every communication device 103a . . . 103n to produce four datasets including three balanced datasets for training, testing and validation and a fourth (remainder) dataset as a holdout dataset that is unbalanced. This process 305 is performed on the communication device 103a . . . 103n side to preserve privacy.

After building the datasets, each communication device 103a . . . 103n sends 307 the sizes and the label distribution to communication device 101. Communication device 101 verifies (in validation operation 309) that each dataset has a size that is large enough (or as large as the next one). Label distribution is the portion of positive/(positive+negative) labels (or the portion of negative/(positive+negative)) if learning from the opposite class).

Still referring to FIG. 3, the evaluation 325 process includes the following:
x_test′ is the reconstructed test sample
rmse=rmse(x_test′, x_test) where is rmse is root mean square
z_scores_test=modified_z_scores(rmse) where modified_z_scores is given by:

$$Mi = \frac{0.675 * ( rmse - {rmse}^{′} )}{median ( \vert rmse - {rmse}^{′} \vert )}$$

Labels y_pred=z_scores_test>mad_threshold which contains a value for a label for a minority class dataset or a majority class dataset (e.g., 1 or 0 sleeping or non-sleeping cell, respectively) whether the z score of its sample is greater or smaller than mad_threshold. As a rule of thumb, mad_threshold is set to 3.5. See e.g., https://www.itl.nist.gov/div898/handbook/eda/section3/eda35h.htm.

In other words, univariate outlier detection is performed on the reconstruction loss to identify those samples whose reconstruction loss differs greatly from the median. Based on that, labeling is performed to indicate minority class sample labels and majority class sample labels (e.g., labels indicating sleeping vs non-sleeping samples, respectively).

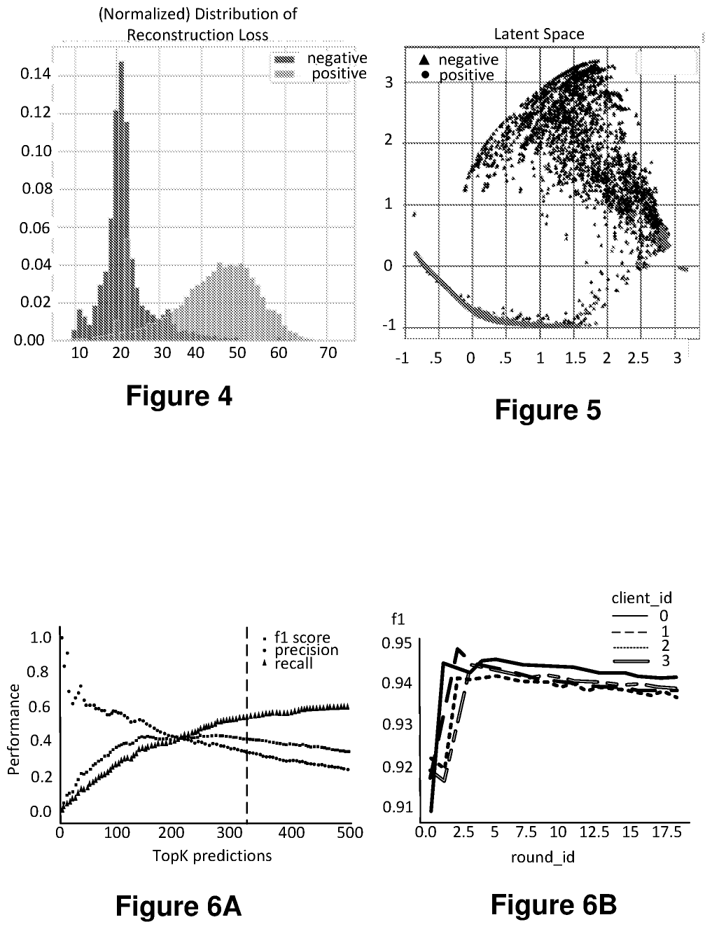

Referring again to FIG. 1, in various embodiments of the present disclosure, each communication device 103a . . . 103n includes the autoencoder that is trained by each communication device 103a . . . 103n to learn a particular class of samples. For example, in some embodiments, the autoencoder is only trained on sleeping cells or only on non-sleeping cells. After the training, the autoencoder generates samples from the opposite class. Given that the autoencoder was not trained with such samples, a reconstruction loss (mean square value between real (x) and the output of the autoencoder (x′) should be high and can be used to distinguish between the different classes. This is illustrated in FIGS. 4 and 5. FIG. 4 is a plot illustrating reconstruction loss of a decentralized autoencoder in accordance with some embodiments of the present disclosure; and FIG. 5 is a plot illustrating latent space of an autoencoder in accordance with some embodiments of the present disclosure. FIGS. 4 and 5 illustrate experimental results when running the decentralized autoencoder of the method of some embodiments (i.e., FIG. 4), and when federating the autoencoder (also referred to herein as “decentralized autoencoder”) on real data (i.e., FIG. 5). FIG. 4 shows a histogram containing the reconstruction loss between positive and negative samples (e.g., sleeping and non-sleeping samples) and shows a distinction in the error between the two classes in the normalized distribution of reconstruction loss. FIG. 5 shows the latent space (the layer denoted as 207 in FIG. 2) and shows a near linearly separable distinction between the two classes.

FIGS. 6A and 6B are plots illustrating evaluation results of a federated learning model (FIG. 6A) and the decentralized autoencoder of some embodiments of the present disclosure (FIG. 6B). FIG. 6A illustrates performance of the classification model used in published patent application WO2020064094, “Method and System for Predicting a State of a Cell in a Radio Access Network”; and FIG. 6B illustrates performance received at each round of federation from the different data centers (e.g., communication devices 103a-103n) of an embodiment of the present disclosure. Referring to FIG. 6B, the x-axis identifies the round of the federation, and the y-axis shows the f1 score. Each curve indicates positive transfer between the data centers which saturates at 0.93 over time.

Referring now to phase 3, the decentralized autoencoder that is produced in various embodiments can be used in different ways.

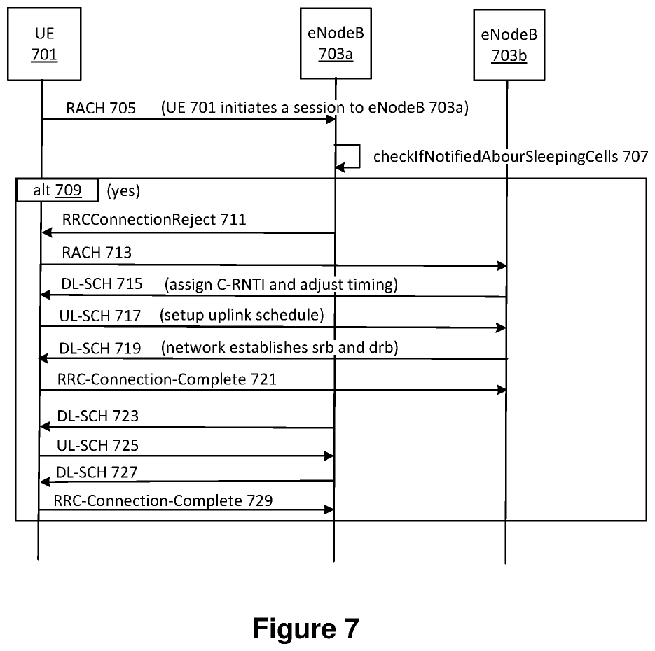

In some embodiments, a Network Operation Center (NOC) of a RAN triggers the decentralized autoencoder periodically using PM counters collected from different sites/cells to predict if one or more cells are going to sleep (or remain available) in the next timeframe. If a cell is going to sleep, this information can be communicated to the cell. Using this information, the cell can then pass this back to the communication devices when they are trying to connect. FIG. 7 is a sequence diagram illustrating a long term evolution (LTE) radio resource control (RRC) connection with sleeping cell awareness in accordance with some embodiments of the present disclosure. An example of a modified RRC connection request process is shown in FIG. 7 where eNodeB 703a has been notified 707 by the NOC (e.g., network node 105a) that it is sleeping. UE 701 then receives 711 a RRCConnectionReject and connects 721 to the next available eNodeB (shown as eNodeB 703b).

Still referring to FIG. 7, the function named checklfNotifiedAboutSleepingCells( ) 707 presently is not standardized but can be included in a standard (e.g., 3GPP) as a new Information Element.

Referring now to Phase 4, in some embodiments, in phase 4 a network node (e.g., a NOC) periodically checks every cell that is reported to be the sleeping and when a cell has no active connections, the cell will be locked to ensure that no new connections are made, a reset is performed and once the reset is complete, the cell is unlocked, and it is ready to receive new connections.

In some embodiments, explainability is used. In an example embodiment, shap (that is, shapely values) is used to further analyze how different features affect the reconstruction loss for each sample to further identify if a sample is sleeping or non-sleeping via the following process:
m is the autoencoder to be explained
sᵢ is the sample to be explained
x_test is the entire sample set (sᵢϵx_test)
x_test′ is the reconstructed sample set
reconstruction_loss=rmse(x_test′−x_test)
For j in top_n_features: where top_n_features are the n top_features with the highest reconstruction loss for sᵢ as computed in reconstruction_loss
   m′=m[index[j]=0] # the feature is omitted from the model's neural parameters
shap_values=shap_values(m′, x_test)

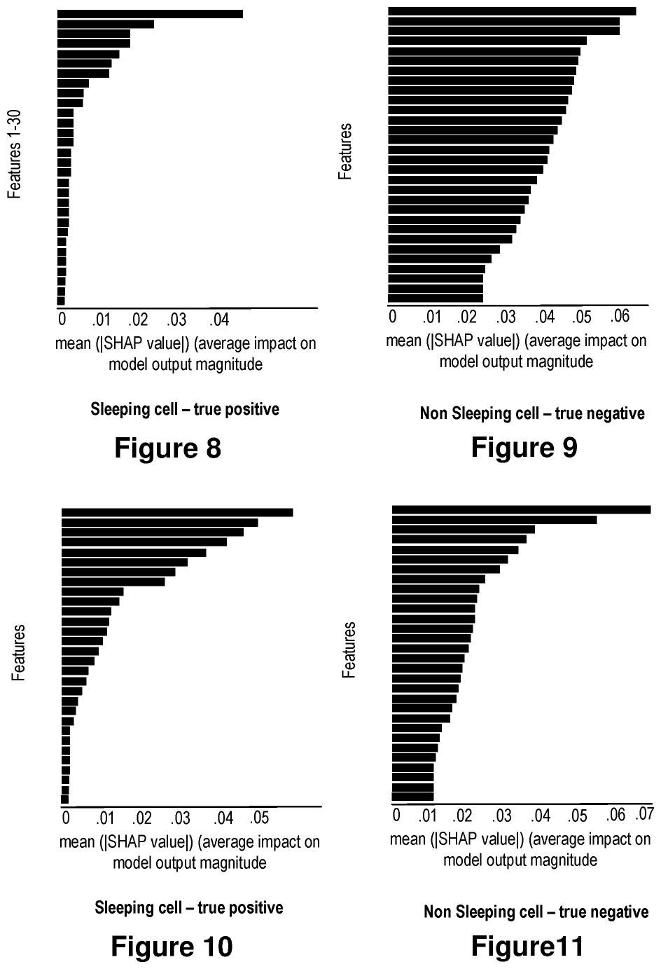

FIGS. 8 and 9 are illustrate results from using shap following the above process. FIG. 8 is a plot illustrating sleeping cell—true positive, and FIG. 9 is a plot illustrating non-sleeping cell—true negative classification. As shown in FIG. 8, in this example embodiment, feature 1 (e.g., kpi_avg_cqi) is the most important feature when it comes to identifying a sleeping cell. However, the decentralized autoencoder based on reconstruction loss can also consider the second sample (feature 2) as a sleeping cell even it is not. The difference in the second sample is that feature 1 (e.g., pmdcpvoldrb) is the top feature and the number of successful cbra connections. Consequently, by using explainability, this case can be identified and the result can be treated accordingly.

FIGS. 10 and 11 are plots illustrating results from using shap following the above process for non-sleeping cells in accordance with some embodiments of the present disclosure. As shown in FIGS. 10 and 11, the KPI for feature 1 (e.g., UL RSSI), followed by feature 2 (e.g., kpi_avg_cqi), feature 3 (e.g., the number of erab success rate), and feature 4 (the number of rrb connection failures) are the top contributing features signifying a non-sleeping cell.

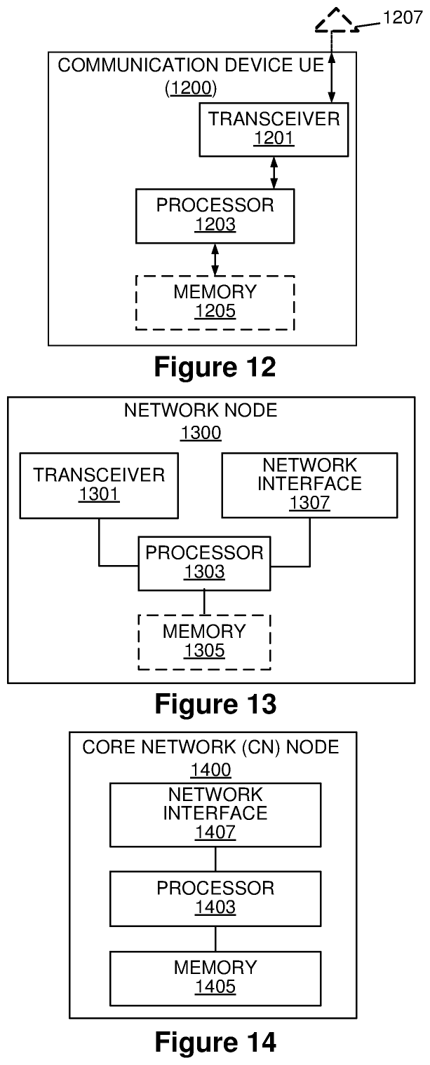

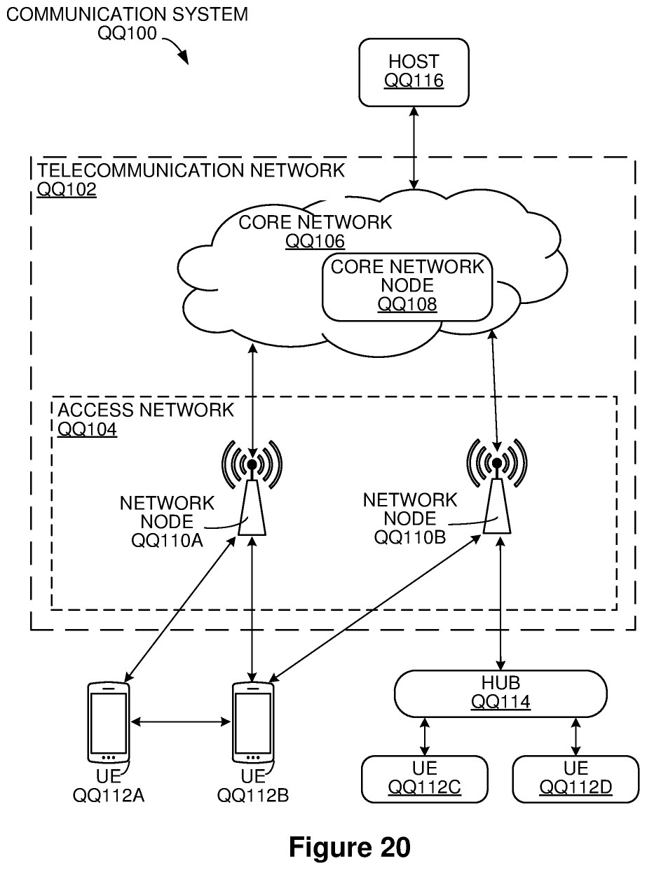

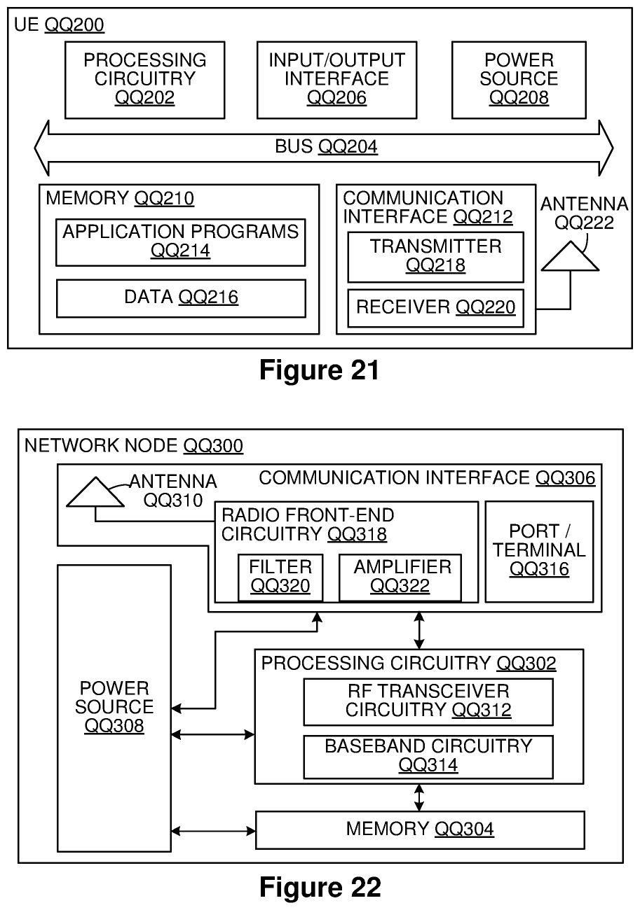

FIG. 12 is a block diagram illustrating elements of a communication device UE 1200 (also referred to as a data center, mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 1200 may be provided, for example, as discussed below with respect to wireless devices UE QQ112A, UE QQ112B, and wired or wireless devices UE QQ112C, UE QQ112D of FIG. 20, UE QQ200 of FIG. 21, and virtualization hardware QQ504 and virtual machines QQ508A, QQ508B of FIG. 24, all of which should be considered interchangeable in the examples and embodiments described herein and be within the intended scope of this disclosure, unless otherwise noted.) As shown, communication device UE may include an antenna 1207 (e.g., corresponding to antenna QQ222 of FIG. 21), and transceiver circuitry 1201 (also referred to as a transceiver, e.g., corresponding to interface QQ212 of FIG. 21 having transmitter QQ218 and receiver QQ220) including a transmitter and a receiver configured to provide uplink and downlink radio communications with a base station(s) (e.g., corresponding to network node QQ110A, QQ110B of FIG. 20, network node QQ300 of FIG. 22 also referred to as a RAN node or radio base station (RBS)) of a radio access network. Communication device UE may also include processing circuitry 1203 (also referred to as a processor, e.g., corresponding to processing circuitry QQ202 of FIG. 21, and control system QQ512 of FIG. 24) coupled to the transceiver circuitry, and, optionally, may include memory circuitry 1205 (also referred to as memory, e.g., corresponding to memory QQ210 of FIG. 20) coupled to the processing circuitry. The memory circuitry 1205 may include computer readable program code that when executed by the processing circuitry 1203 causes the processing circuitry to perform operations according to embodiments disclosed herein. According to other embodiments, processing circuitry 1203 may be defined to include memory so that separate memory circuitry is not required. Communication device UE may also include an interface (such as a user interface) coupled with processing circuitry 1203, and/or communication device UE may be incorporated in a vehicle.

Still referring to FIG. 12, according to other embodiments, the communication device does not include memory and a network can be used as a memory. In an example embodiment, each communication device can stream its data (e.g., PM counters) over the network to another communication device or network node. The other communication device or network node (each also without memory) can train the layers of a feed forward neural network (e.g., forward/backward propagation) on top of the stream. Averaging can take place in another communication device or network node that is similar and has enough memory (e.g., embedded field programmable gate array (FPGA) memory) to store the updates received from other communication devices or network nodes. The trained neural network is sent to a communication device(s) or network node(s) in the network with memory to perform inference.

As discussed herein, operations of communication device UE may be performed by processing circuitry 1203, optional memory (as discussed herein), and/or transceiver circuitry 1201. For example, processing circuitry 1203 may control transceiver circuitry 1201 to transmit communications through transceiver circuitry 1201 over a radio interface to a radio access network node (also referred to as a base station) and/or to receive communications through transceiver circuitry 1201 from a RAN node over a radio interface. Moreover, processing circuitry 1203 can perform respective operations (e.g., operations discussed below with respect to example embodiments relating to communication devices). According to some embodiments, a communication device UE 1200 and/or an element(s)/function(s) thereof may be embodied as a virtual node/nodes and/or a virtual machine/machines.

FIG. 13 is a block diagram illustrating elements of a network node 1300 (also referred to as a radio access network node, base station, radio base station, eNodeB/eNB, gNodeB/gNB, etc.) of a Radio Access Network (RAN) configured to provide cellular communication according to embodiments of inventive concepts. (Network node 1300 may be provided, for example, as discussed below with respect to network node QQ110A, QQ110B of FIG. 20, network node QQ300 of FIG. 22, hardware QQ504 and/or virtual machine QQ508A, QQ508B of FIG. 24, all of which should be considered interchangeable in the examples and embodiments described herein and be within the intended scope of this disclosure, unless otherwise noted.) As shown, the network node may include transceiver circuitry 1301 (also referred to as a transceiver, e.g., corresponding to portions of RF transceiver circuitry QQ312 and radio front end circuitry QQ318 of FIG. 22) including a transmitter and a receiver configured to provide uplink and downlink radio communications with mobile terminals. The network node may include network interface circuitry 1307 (also referred to as a network interface, e.g., corresponding to portions of communication interface QQ306 of FIG. 22) configured to provide communications with other nodes (e.g., with other base stations) of the communication network and/or core network CN. The network node may also include processing circuitry 1303 (also referred to as a processor, e.g., corresponding to processing circuitry QQ302 of FIG. 22) coupled to the transceiver circuitry, optionally, may include memory circuitry 1305 (also referred to as memory, e.g., corresponding to memory QQ304 of FIG. 22) coupled to the processing circuitry. The memory circuitry 1305 may include computer readable program code that when executed by the processing circuitry 1303 causes the processing circuitry to perform operations according to embodiments disclosed herein. According to other embodiments, processing circuitry 1303 may be defined to include memory so that a separate memory circuitry is not required.

Still referring to FIG. 13, according to other embodiments, the network node does not include memory and a network can be used as a memory. In an example embodiment, each network node can stream its data over the network to another communication device or network node. The other network node or communication device (each also without memory) can train the layers of a feed forward neural network (e.g., forward/backward propagation) on top of the stream. Averaging can take place in another network node or communication device that is similar and has enough memory (e.g., embedded field programmable gate array (FPGA) memory) to store the updates received from other network nodes or communication devices. The trained neural network is sent to a network node(s) or communication device(s) in the network with memory to perform inference.

As discussed herein, operations of the network node may be performed by processing circuitry 1303, network interface 1307, optional memory (as discussed herein), and/or transceiver 1301. For example, processing circuitry 1303 may control transceiver 1301 to transmit downlink communications through transceiver 1301 over a radio interface to one or more mobile terminals UEs and/or to receive uplink communications through transceiver 1301 from one or more mobile terminals UEs over a radio interface. Similarly, processing circuitry 1303 may control network interface 1307 to transmit communications through network interface 1307 to one or more other network nodes and/or to receive communications through network interface from one or more other network nodes. Moreover, processing circuitry 1303 can perform respective operations (e.g., operations discussed below with respect to example embodiments relating to network nodes). According to some embodiments, network node 1300 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 14 is a block diagram illustrating elements of a core network (CN) node (e.g., an SMF (session management function) node, an AMF (access and mobility management function) node, etc.) of a communication network configured to provide cellular communication according to embodiments of inventive concepts. (CN node 1400 may be provided, for example, as discussed below with respect to core network node QQ108 of FIG. 20, hardware QQ504 or virtual machine QQ508A, QQ508B of FIG. 24, all of which should be considered interchangeable in the examples and embodiments described herein and be within the intended scope of this disclosure, unless otherwise noted). As shown, the CN node may include network interface circuitry 1407 configured to provide communications with other nodes of the core network and/or the radio access network RAN. The CN node may also include a processing circuitry 1403 (also referred to as a processor,) coupled to the network interface circuitry, and memory circuitry 1405 (also referred to as memory) coupled to the processing circuitry. The memory circuitry 1405 may include computer readable program code that when executed by the processing circuitry 1403 causes the processing circuitry to perform operations according to embodiments disclosed herein. According to other embodiments, processing circuitry 1403 may be defined to include memory so that a separate memory circuitry is not required.

As discussed herein, operations of the CN node may be performed by processing circuitry 1403 and/or network interface circuitry 1407. For example, processing circuitry 1403 may control network interface circuitry 1407 to transmit communications through network interface circuitry 1407 to one or more other network nodes and/or to receive communications through network interface circuitry from one or more other network nodes. Moreover, modules may be stored in memory 1405, and these modules may provide instructions so that when instructions of a module are executed by processing circuitry 1403, processing circuitry 1403 performs respective operations. According to some embodiments, CN node 1400 and/or an element(s)/function(s) thereof may be embodied as a virtual node/nodes and/or a virtual machine/machines.

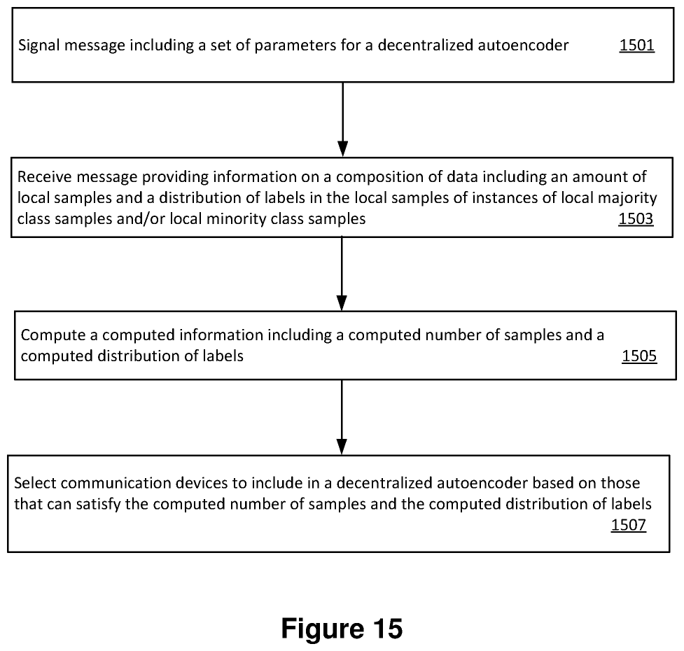

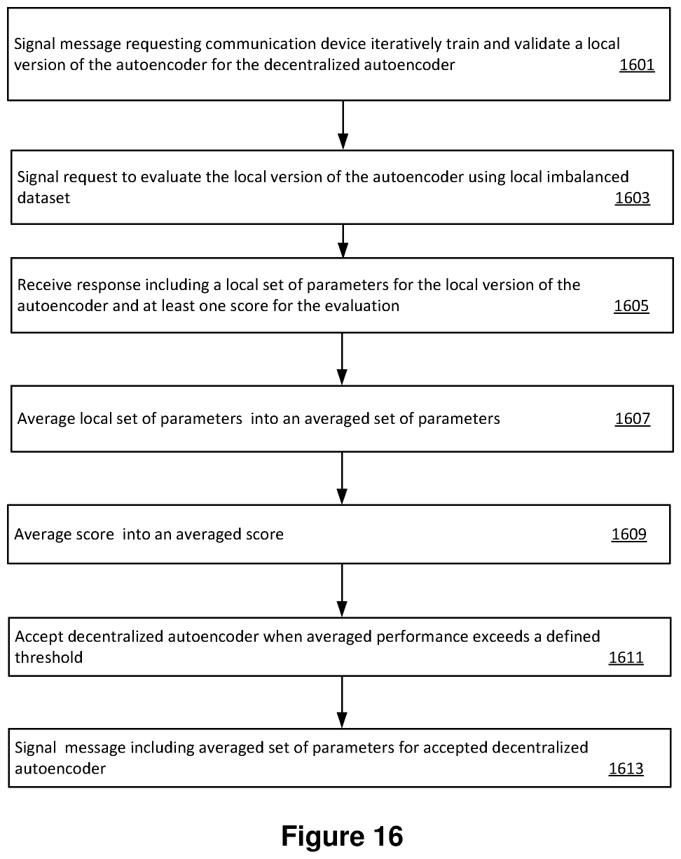

In the description that follows, while the communication device may be any of the communication device 1200, wireless device QQ112A, QQ112B, wired or wireless devices UE QQ112C, UE QQ112D, UE QQ200, virtualization hardware QQ504, virtual machines QQ508A, QQ508B, or UE QQ606, the communication device 1200 shall be used to describe the functionality of the operations of the communication device. Operations of a first communication device 101 (implemented using the structure of the block diagram of FIG. 12) will now be discussed with reference to the flow charts of FIGS. 15 and 16 according to some embodiments of inventive concepts. For example, processing circuitry 1203 performs respective operations of the flow charts.

Referring first to FIG. 15, a method performed by a first communication device (101, 1200) in a communication network for managing a decentralized autoencoder for detection or prediction of a minority class from an imbalanced dataset is provided. The imbalanced dataset including a plurality of local majority class samples and a plurality of local minority class samples. The method includes signalling (1501) a message to a plurality of other communication devices in the communication network. The message includes a set of parameters for the decentralized autoencoder. The method further includes receiving (1503) a message from at least some of the plurality of other communication devices providing information on a composition of data of the communication device that signaled the message. The composition includes an amount of local samples and a distribution of labels in the local samples of instances of the local majority class samples and/or the local minority class samples of the communication device. The method further includes computing (1505), from the information, a computed information comprising a computed number of samples and a computed distribution of labels for aggregated local majority class samples and aggregated local minority class samples for the at least some of the plurality of other communication devices. The method further includes selecting (1507) a set of communication devices from the at least some of the plurality of other communication devices to include in the decentralized autoencoder based on the communication devices that can satisfy the computed number of samples and the computed distribution of labels.

In some embodiments, the computed number of samples and the computed distribution of labels may be beneficial when selecting (also referred to herein as filtering) the local communication devices that have an extremely imbalanced dataset such that those local communication devices can be selected and included in the decentralized autoencoder federation. In some embodiments, this way, the decentralized autoencoder federation can happen only on computation communication devices that are suitable for rare even detection. The rest of the communication nodes can be grouped separately and can have a different federation without an autoencoder architecture (e.g., can be based on another learning technique).

Moreover, in some embodiments, two decentralized autoencoder federations can train separately on two different federations. For example:
Federation 1: on communication devices where there is imbalance and the imbalance occurs due to the high number of instances in positive class (e.g., cell is sleeping)
Federation 2: on communication devices where there is imbalance and the imbalance occurs due to the high number of instances in negative class (e.g., cell is not sleeping) While Federation 1 may be unlikely, there might be some cases due to, e.g., error in data collection or the location, hardware, and/or context of a base station.

In some embodiments, the local samples include data of a measurement of a feature, and wherein the computed number of samples and the computed distribution of labels comprise a number of first samples from the set of communication devices having the local majority class label and a number of second samples from the set of communication devices having the local minority class label.

In some embodiments, the computed number of samples include a set of balanced datasets comprising a training dataset, a test dataset, a validation dataset, and an imbalanced dataset; and the method further includes signalling (1601) a request message to the set of communication devices requesting that each communication device in the set of communication devices iteratively train and validate a local version of the autoencoder on the training dataset and the validation dataset and the set of parameters for the decentralized autoencoder. The iterative training is performed by including a dataset from either the local majority class samples or the local minority class samples that has a greatest number of samples in the training dataset and the validation dataset, respectively, as input to the local version of the autoencoder.

Referring now to FIG. 16, in some embodiments, the method further includes, subsequent to the iterative training, signalling (1603) a request to the set of communication devices requesting that each communication device in the set of communication devices evaluate the local version of the autoencoder using the imbalanced dataset. The method further includes receiving (1605) a response to the request for evaluation from at least some of the set of communication devices. The response includes a local set of parameters for the local version of the autoencoder and at least one score for the evaluation. The at least one score is based on a reconstruction loss of the local version of the autoencoder using the imbalanced dataset as input to the local version of the autoencoder. The imbalanced dataset contains either the local majority class dataset or the local minority class dataset that was not used in the iterative training. The method further includes averaging (1607) the local set of parameters received from the at least some of the set of communication devices into an averaged set of parameters. The method further includes averaging (1609) the at least one score received from the at least some of the set of communication devices into an averaged score. The method further includes accepting (1611) the decentralized autoencoder when the averaged score exceeds a defined threshold.

In some embodiments, the method further includes signalling (1613) a message to the at least some of the set of communication devices including the averaged set of parameters for the accepted decentralized autoencoder.

In some embodiments, the communication network is a radio access network, RAN. The local samples include data of a measurement of a key performance indicator, KPI, of the RAN. The local majority dataset includes a first subset of the local samples where each sample of the first subset is labelled as a sleeping cell of the RAN; and the local minority dataset includes a second subset of the local samples where each sample in the second subset is labelled as a non-sleeping cell of the RAN.

In some embodiments, the communication network is a radio access network, RAN. The local samples include data of a measurement of a key performance indicator, KPI, of the RAN. The local majority dataset includes a first subset of the local samples where each sample of the first subset is labelled as a non-sleeping cell of the RAN; and the local minority dataset comprises a second subset of the local samples where each sample in the second subset is labelled as a sleeping cell of the RAN.

Various operations from the flow chart of FIG. 16 may be optional with respect to some embodiments of a method performed by a first communication device. For example, operations of blocks 1601-1613 of FIG. 16 may be optional.

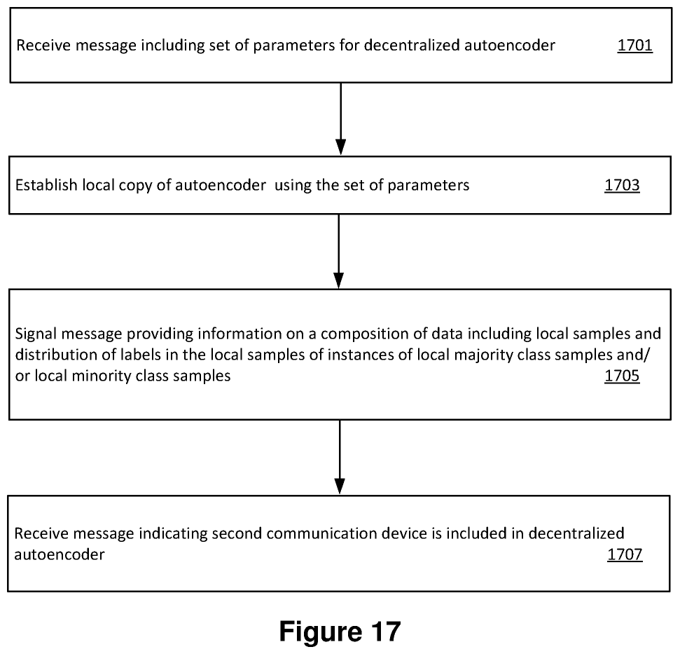

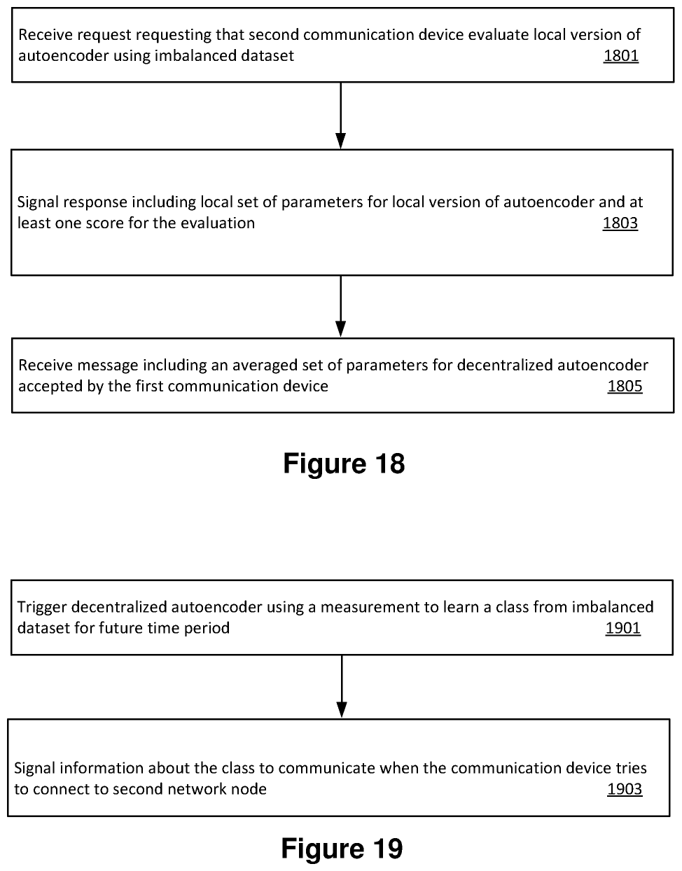

Operations of a second communication device, e.g., 103a (implemented using the structure of the block diagram of FIG. 12) will now be discussed with reference to the flow charts of FIGS. 17 and 18 according to some embodiments of inventive concepts. For example, processing circuitry 1203 performs respective operations of the flow charts.

Referring first FIG. 17, a method performed by a second communication device (103a, 1200) in a communication network (100) is provided. The second communication device comprising an autoencoder that is also trained across a plurality of other communication devices, thereby forming a decentralized autoencoder, for detection or prediction of a minority class from an imbalanced dataset that includes a plurality of local majority class samples and a plurality of local minority class samples to the communication devices. The method includes receiving (1701) a message from a first communication device in the communication network. The message includes a set of parameters for the decentralized autoencoder. The method further includes establishing (1703) a local copy of the autoencoder at the second communication device using the set of parameters. The method further includes signalling (1705) a message to the first communication device providing information on a composition of data of the second communication device. The composition includes an amount of local samples and a distribution of labels in the local samples of instances of the local majority class samples and/or the local minority class samples of the second communication device. The method further includes receiving (1707) a message from the first communication device indicating that the second communication device is included in the decentralized autoencoder based on the first communication device determining that the second communication device can satisfy a computed number of samples and a computed distribution of labels for the local majority class samples and the local minority class samples at the second communication device.

In some embodiments, the local samples include data of a measurement of a feature; and the computed number of samples and the computed distribution of labels include a number of first samples from the second communication device having the local majority class label and a number of second samples from the second communication device having the local minority class label.

Referring now to FIG. 18, in some embodiments, the computed number of samples include a set of balanced datasets comprising a training dataset, a test dataset, a validation dataset, and an imbalanced dataset; and the method further includes receiving (1801) a request message from the first communication device requesting that the second communication device iteratively train and validate the local version of the autoencoder on the training dataset and the validation dataset and the set of parameters for the decentralized autoencoder. The iterative training is performed by including either the local majority class samples or the local minority class samples that has a greatest number of samples in the training dataset and the validation dataset, respectively, as input to the local version of the autoencoder.

In some embodiments, the method further includes, subsequent to the iterative training, receiving (1803) a request from the first communication device requesting that the second communication device evaluate the local version of the autoencoder using the imbalanced dataset. The method further includes signalling (1805) a response to the first communication device to the request for evaluation. The response includes a local set of parameters for the local version of the autoencoder and at least one score for the evaluation. The at least one score is based on a reconstruction loss of the local version of the autoencoder using the imbalanced dataset as input to the local version of the autoencoder, and the imbalanced dataset contains either the local majority class dataset or the local minority class dataset that was not used in the iterative training.

In some embodiments, the method further includes receiving (1807) a message from the first communication device including an averaged set of parameters for the decentralized autoencoder accepted by the first communication device.

In some embodiments, the communication network is a radio access network, RAN; the local samples include data of a measurement of a key performance indicator, KPI, of the RAN; the local majority dataset include a first subset of the local samples where each sample of the first subset is labelled as a sleeping cell of the RAN; and the local minority dataset includes a second subset of the local samples where each sample in the second subset is labelled as a non-sleeping cell of the RAN.

In some embodiments, the communication network is a RAN; the local samples include data of a measurement of a key performance indicator, KPI, of the RAN; the local majority dataset includes a first subset of the local samples where each sample of the first subset is labelled as a non-sleeping cell of the RAN; and the local minority dataset includes a second subset of the local samples where each sample in the second subset is labelled as a sleeping cell of the RAN.

Various operations from the flow chart of FIG. 18 may be optional with respect to some embodiments of a method performed by a second communication device. For example, operations of blocks 1801-1807 of FIG. 18 may be optional.

Operations of a first network node 105a (implemented using the structure of FIG. 13) will now be discussed with reference to the flow chart of FIG. 19 according to some embodiments of the present disclosure. In the description that follows, while the first network node may be any of the network node 1300, network node QQ110A, QQ110B, QQ300, QQ606, hardware QQ504, or virtual machine QQ508A, QQ508B, the network node 1300 shall be used to describe the functionality of the operations of the first network node. For example, processing circuitry 1303 performs respective operations of the flow chart.

Referring to FIG. 19, a method performed by a first network node (105a, 1300) in a communication network for using a decentralized autoencoder for detection or prediction of a minority class from an imbalanced dataset that includes a plurality of local majority class samples and a plurality of local minority class samples is provided. The method includes triggering (1901) the decentralized autoencoder using a measurement from the communication network to learn a class from the imbalanced dataset for a future time period. The method further includes signalling (1903) information about the class to a second network node to communicate to a communication device when the communication device tries to connect to the second network node.

In some embodiments, the communication network is a radio access network, RAN; the measurement includes data of a measurement of a key performance indicator, KPI, of the RAN; the local majority samples includes a first subset of the samples where each sample of the first subset is labelled as a non-sleeping cell of the RAN; the local minority dataset samples include a second subset of the samples where each sample in the second subset is labelled as a sleeping cell of the RAN; and the learn a class is a classification that at least one cell of the RAN is either sleeping or not sleeping in the future time period.

Although communication device 1200 and network node 1300 are illustrated in the example block diagrams of FIGS. 12 and 13 each may represent a device that includes the illustrated combination of hardware components, other embodiments may comprise communication devices and network nodes with different combinations of components. It is to be understood that each of a communication device and a network node comprise any suitable combination of hardware and/or software needed to perform the tasks, features, functions, and methods disclosed herein. Moreover, while the components of each of a communication device and a network node are depicted as single boxes located within a larger box, or nested within multiple boxes, in practice, each device may comprise multiple different physical components that make up a single illustrated component (e.g., a memory may comprise multiple separate hard drives as well as multiple RAM modules).

FIG. 20 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 20 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 21 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 21. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 21.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 22 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 22 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

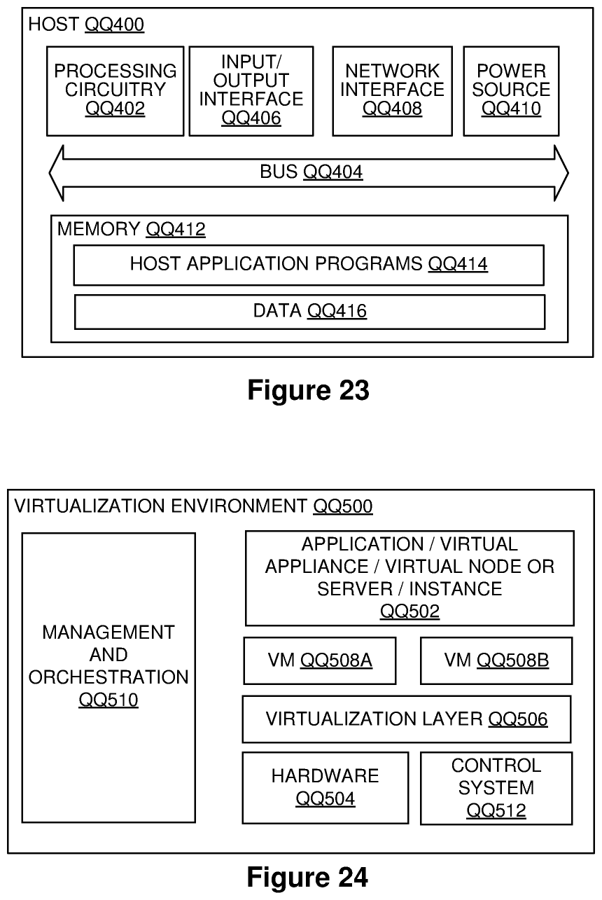

FIG. 23 is a block diagram of a host QQ400, which may be an embodiment of the host QQ116 of FIG. 20, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 21 and 22, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 24 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method performed by a first communication device in a communication network for managing a decentralized autoencoder for detection or prediction of a minority class from an imbalanced dataset, the imbalanced dataset including a plurality of local majority class samples and a plurality of local minority class samples, the method comprising:
signalling a message to a plurality of other communication devices in the communication network, the message comprising a set of parameters for the decentralized autoencoder;
receiving a message from at least some of the plurality of other communication devices providing information on a composition of data of the communication device that signaled the message, the composition comprising an amount of local samples and a distribution of labels in the local samples of instances of the local majority class samples and/or the local minority class samples of the communication device;
computing, from the information, a computed information comprising a computed number of samples and a computed distribution of labels for aggregated local majority class samples and aggregated local minority class samples for the at least some of the plurality of other communication devices; and
selecting a set of communication devices from the at least some of the plurality of other communication devices to include in the decentralized autoencoder based on the communication devices that can satisfy the computed number of samples and the computed distribution of labels.

2. The method of claim 1, wherein the local samples comprise data of a measurement of a feature, and wherein the computed number of samples and the computed distribution of labels comprise a number of first samples from the set of communication devices having the local majority class label and a number of second samples from the set of communication devices having the local minority class label.

3. The method of claim 1, wherein the computed number of samples comprise a set of balanced datasets comprising a training dataset, a test dataset, a validation dataset, and an imbalanced dataset, and further comprising:
signalling a request message to the set of communication devices requesting that each communication device in the set of communication devices iteratively train and validate a local version of the autoencoder on the training dataset and the validation dataset and the set of parameters for the decentralized autoencoder, wherein the iterative training is performed by including a dataset from either the local majority class samples or the local minority class samples that has a greatest number of samples in the training dataset and the validation dataset, respectively, as input to the local version of the autoencoder.

4. The method of claim 3, further comprising:
subsequent to the iterative training, signalling a request to the set of communication devices requesting that each communication device in the set of communication devices evaluate the local version of the autoencoder using their local imbalanced dataset;
receiving a response to the request for evaluation from at least some of the set of communication devices, the response including a local set of parameters for the local version of the autoencoder and at least one score for the evaluation, wherein the at least one score is based on a reconstruction loss of the local version of the autoencoder using the imbalanced dataset as input to the local version of the autoencoder, and wherein the imbalanced dataset contains either the local majority class dataset or the local minority class dataset that was not used in the iterative training;
averaging the local set of parameters received from the at least some of the set of communication devices into an averaged set of parameters;
averaging the at least one score received from the at least some of the set of communication devices into an averaged score; and
accepting the decentralized autoencoder when the averaged performance exceeds a defined threshold.

5. The method of claim 4, further comprising:
signalling a message to the at least some of the set of communication devices comprising the averaged set of parameters for the accepted decentralized autoencoder.

6. The method of claim 1, wherein the communication network is a radio access network, RAN;
wherein the local samples comprise data of a measurement of a key performance indicator, KPI, of the RAN;
wherein the local majority dataset comprises a first subset of the local samples where each sample of the first subset is labelled as a sleeping cell of the RAN; and
wherein the local minority dataset comprises a second subset of the local samples where each sample in the second subset is labelled as a non-sleeping cell of the RAN.

7. The method of claim 1, wherein the communication network is a radio access network, RAN;
wherein the local samples comprise data of a measurement of a key performance indicator, KPI, of the RAN;
wherein the local majority dataset comprises a first subset of the local samples where each sample of the first subset is labelled as a non-sleeping cell of the RAN; and
wherein the local minority dataset comprises a second subset of the local samples where each sample in the second subset is labelled as a sleeping cell of the RAN.

8. A first communication device for managing a decentralized autoencoder for detection or prediction of a minority class from an imbalanced dataset, the imbalanced dataset including a plurality of local majority class samples and a plurality of local minority class samples, the first communication device comprising:
at least one processor configured to perform operations comprising:
signal a message to a plurality of other communication devices in the communication network, the message comprising a set of parameters for a decentralized autoencoder;
receive a message from at least some of the plurality of other communication devices providing information on a composition of data of the communication device that signaled the message, the composition comprising an amount of local samples and a distribution of labels in the local samples of instances of the local majority class samples and/or the local minority class samples of the communication device;
compute, from the information, a computed information comprising a computed number of samples and a computed distribution of labels for aggregated local majority class samples and aggregated local minority class samples for the at least some of the plurality of the at least some of the plurality of other communication devices; and
select a set of communication devices from the at least some of the plurality of other communication devices to include in a decentralized autoencoder based on the communication devices that can satisfy the computed number of samples and the computed distribution of labels.

9. The first communication device of claim 8, wherein the local samples comprise data of a measurement of a feature, and wherein the computed number of samples and the computed distribution of labels comprise a number of first samples from the set of communication devices having the local majority class label and a number of second samples from the set of communication devices having the local minority class label.

10.-15. (canceled)

16. A method performed by a second communication device in a communication network, the second communication device comprising an autoencoder that is also trained across a plurality of other communication devices, thereby forming a decentralized autoencoder, for detection or prediction of a minority class from an imbalanced dataset that includes a plurality of local majority class samples and a plurality of local minority class samples to the communication devices, the method comprising:
receiving a message from a first communication device in the communication network, the message comprising a set of parameters for the decentralized autoencoder;
establishing a local copy of the autoencoder at the second communication device using the set of parameters;
signalling a message to the first communication device providing information on a composition of data of the second communication device, the composition comprising an amount of local samples and a distribution of labels in the local samples of instances of the local majority class samples and/or the local minority class samples of the second communication device; and
receiving a message from the first communication device indicating that the second communication device is included in the decentralized autoencoder based on the first communication device determining that the second communication device can satisfy a computed number of samples and a computed distribution of labels for the local majority class samples and the local minority class samples at the second communication device.

17. The method of claim 16, wherein the local samples comprise data of a measurement of a feature, and wherein the computed number of samples and the computed distribution of labels comprise a number of first samples from the second communication device having the local majority class label and a number of second samples from the second communication device having the local minority class label.

18. The method of claim 16, wherein the computed number of samples comprise a set of balanced datasets comprising a training dataset, a test dataset, a validation dataset, and an imbalanced dataset, and further comprising:
receiving a request message from the first communication device requesting that the second communication device iteratively train and validate the local version of the autoencoder on the training dataset and the validation dataset and the set of parameters for the decentralized autoencoder, wherein the iterative training is performed by including either the local majority class samples or the local minority class samples that has a greatest number of samples in the training dataset and the validation dataset, respectively, as input to the local version of the autoencoder.

19. The method of claim 18, further comprising:
subsequent to the iterative training, receiving a request from the first communication device requesting that the second communication device evaluate the local version of the autoencoder using the imbalanced dataset; and
signalling a response to the first communication device to the request for evaluation, the response including a local set of parameters for the local version of the autoencoder and at least one score for the evaluation, wherein the at least one score is based on a reconstruction loss of the local version of the autoencoder using the imbalanced dataset as input to the local version of the autoencoder, and wherein the imbalanced dataset contains either the local majority class dataset or the local minority class dataset that was not used in the iterative training.

20. The method of claim 19, further comprising:
receiving a message from the first communication device comprising an averaged set of parameters for the decentralized autoencoder accepted by the first communication device.

21. The method of claim 16, wherein the communication network is a radio access network, RAN;
wherein the local samples comprise data of a measurement of a key performance indicator, KPI, of the RAN;
wherein the local majority dataset comprises a first subset of the local samples where each sample of the first subset is labelled as a sleeping cell of the RAN; and
wherein the local minority dataset comprises a second subset of the local samples where each sample in the second subset is labelled as a non-sleeping cell of the RAN.

22. The method of claim 16, wherein the communication network is a radio access network, RAN;
wherein the local samples comprise data of a measurement of a key performance indicator, KPI, of the RAN;
wherein the local majority dataset comprises a first subset of the local samples where each sample of the first subset is labelled as a non-sleeping cell of the RAN; and
wherein the local minority dataset comprises a second subset of the local samples where each sample in the second subset is labelled as a sleeping cell of the RAN.

23.-30. (canceled)

31. A method performed by a first network node in a communication network for using a decentralized autoencoder for detection or prediction of a minority class from an imbalanced dataset that includes a plurality of local majority class samples and a plurality of local minority class samples, the method comprising:
triggering the decentralized autoencoder using a measurement from the communication network to learn a class from the imbalanced dataset for a future time period; and
signalling information about the class to a second network node to communicate to a communication device when the communication device tries to connect to the second network node.

32. The method of claim 31, wherein the communication network is a radio access network, RAN;
wherein the measurement comprises data of a measurement of a key performance indicator, KPI, of the RAN;
wherein the local majority samples comprises a first subset of the samples where each sample of the first subset is labelled as a non-sleeping cell of the RAN; and
wherein the local minority dataset samples comprises a second subset of the samples where each sample in the second subset is labelled as a sleeping cell of the RAN; and
wherein the learn a class is a classification that at least one cell of the RAN is either sleeping or not sleeping in the future time period.

33.-40. (canceled)

41. The first communication device of claim 8, wherein the computed number of samples comprise a set of balanced datasets comprising a training dataset, a test dataset, a validation dataset, and an imbalanced dataset, and the at least one processor is configured to perform further operations comprising:
signal a request message to the set of communication devices requesting that each communication device in the set of communication devices iteratively train and validate a local version of the autoencoder on the training dataset and the validation dataset and the set of parameters for the decentralized autoencoder, wherein the iterative training is performed by including a dataset from either the local majority class samples or the local minority class samples that has a greatest number of samples in the training dataset and the validation dataset, respectively, as input to the local version of the autoencoder.

42. The first communication device of claim 8, wherein the computed number of samples comprise a set of balanced datasets comprising a training dataset, a test dataset, a validation dataset, and an imbalanced dataset, and the at least one processor is configured to perform further operations comprising:
subsequent to the iterative training, signal a request to the set of communication devices requesting that each communication device in the set of communication devices evaluate the local version of the autoencoder using their local imbalanced dataset;
receive a response to the request for evaluation from at least some of the set of communication devices, the response including a local set of parameters for the local version of the autoencoder and at least one score for the evaluation, wherein the at least one score is based on a reconstruction loss of the local version of the autoencoder using the imbalanced dataset as input to the local version of the autoencoder, and wherein the imbalanced dataset contains either the local majority class dataset or the local minority class dataset that was not used in the iterative training;
average the local set of parameters received from the at least some of the set of communication devices into an averaged set of parameters;
average the at least one score received from the at least some of the set of communication devices into an averaged score; and
accept the decentralized autoencoder when the averaged performance exceeds a defined threshold.
